(19) United States
(12) Patent Application Publication
(10) Pub. No.: US 2018/0051618 A1
(43) Pub. Date: Feb. 22, 2018

(54) GEOMETRICALLY OPTIMIZED GAS SENSOR HEAT SHIELD

(71) Applicant: GM GLOBAL TECHNOLOGY OPERATIONS LLC, Detroit, MI (US)

(72) Inventors: Vincent J. Tylutki, Livonia, MI (US); Loai El-Samawi, Troy, MI (US)

(21) Appl. No.: 15/240,020

(22) Filed: Aug. 18, 2016

(51) Int. Cl. F01N 13/14; G01D 11/24

(52) U.S. Cl. CPC F01N 13/14; F01N 2560/02; F01N 2260/20; G01D 11/245

(57) ABSTRACT

Provided herein are gas sensor heat shields comprising at least one wall having a top edge and a bottom edge, the wall forming a body, a base connected proximate the wall bottom edge defining a bottom diameter, the base including an aperture capable of receiving a gas sensor, and a circumferential lip proximate the wall top edge extending radially outward and defining an outer lip diameter, wherein the at least one wall is tapered radially outward at an angle of about 3 degrees to about 17 degrees, and the ratio of the outer lip diameter to bottom diameter is at least about 5:3.5. Heat shields can be used to protect gas sensors from heat, specifically those used for exhaust gas systems servicing internal combustion engines and turbochargers.

### INTRODUCTION

Internal combustion engines (ICE) operate at very high temperatures, and appurtenant components such as exhaust gas manifolds and conduits are exposed to significant levels of heat. The heat can be harmful to some neighboring components if left unprotected, such as gas sensors. For example, oxygen sensors deployed on turbocharger exhaust gas circulation conduits can be subjected to temperatures over 600° C. Heat shields can be employed to protect sensitive components from heat, but dense packaging of components within a system, particularly automobile and motorcycle systems, can pose a challenge to designing space-efficient heat shields.

### SUMMARY

One or more exemplary embodiments address the above issues by providing space-efficient gas sensor heat shields with optimized heat-protecting geometries.

According to an aspect of an exemplary embodiment, a gas sensor heat shield is provided. The heat shield can include at least one wall having a top edge and a bottom edge, wherein the wall forms a body, a base connected proximate the wall bottom edge defining a bottom diameter and a normal height relative to the wall top edge, wherein the base includes an aperture capable of receiving a gas sensor, and a circumferential lip proximate the wall top edge extending radially outward and defining an outer lip diameter. The at least one wall can be tapered radially outward at an angle of about 3 degrees to about 17 degrees, and the ratio of the outer lip diameter to bottom diameter can be at least about 5:3.5. The heat shields can be utilized for exhaust gas systems servicing ICEs and turbochargers.

According to an aspect of an exemplary embodiment, exhaust gas monitoring systems are included. An exhaust gas monitoring system can include an exhaust gas conduit including a wall defining a passage through which exhaust gas can collect or travel, a gas sensor having a first end disposed within the exhaust gas conduit and a second end disposed outside the exhaust gas conduit, an engine and/or turbocharger shield including an aperture, and a gas sensor heat shield disposed within the engine and/or turbocharger shield aperture, the gas sensor heat shield including at least one wall having a top edge and a bottom edge, wherein the wall forms a body; a base connected proximate the wall bottom edge defining a bottom diameter and a normal height relative to the wall top edge, wherein the base includes an aperture through which the gas sensor is positioned, and a circumferential lip proximate the wall top edge extending radially outward and defining an outer lip diameter. The at least one wall can be tapered radially outward at an angle of about 3 degrees to about 17 degrees, and the lip can be positioned above the engine and/or turbocharger shield relative to the exhaust gas conduit and overlaps the engine and/or turbocharger shield at least 8 mm. A vertical gap between the heat shield lip and the engine and/or turbocharger shield can be at most 9 mm.

Although many of the embodiments herein are describe in relation to oxygen sensors used for exhaust gas systems servicing ICEs and turbochargers, the embodiments herein are generally suitable for all gas sensors operating in high temperature environments.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a cross-sectional side-view of a heat shield, according to one or more embodiments;

FIG. 2 illustrates a cross-sectional side-view of an exhaust gas monitoring system, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are gas sensor heat shields which are space-efficient and geometrically optimized to shield gas sensors from heat in high temperature environments. The geometry of heat shields provided herein obviate the need to fully cover a gas sensor, and therefore reduce material and manufacturing costs in addition to saving space in densely packed component areas, such as in exhaust gas systems servicing ICEs and turbochargers.

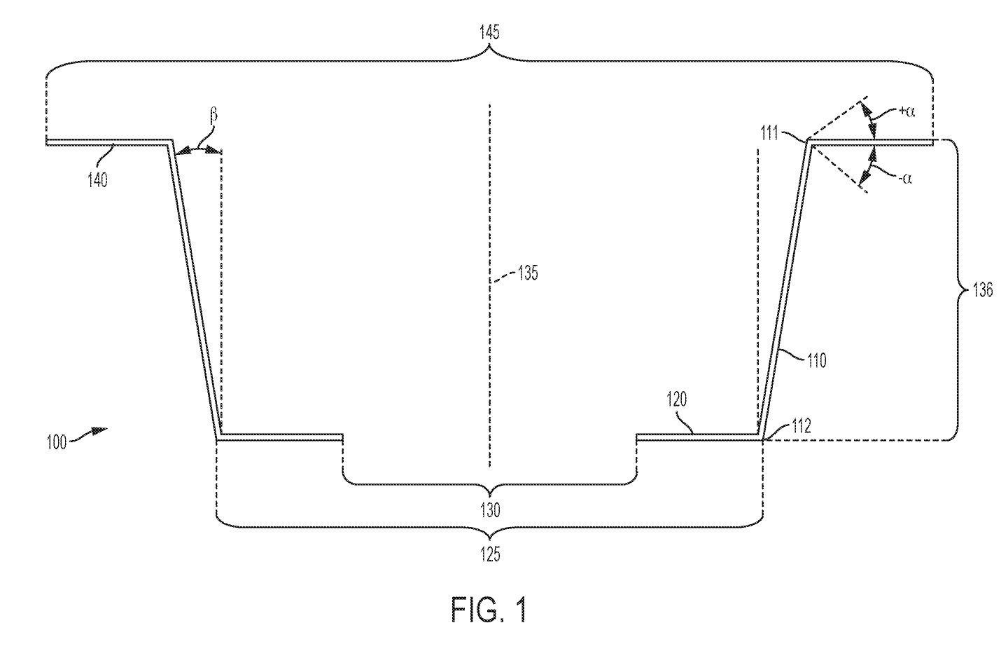

Referring now to the drawings, wherein like reference numbers refer to like features throughout the several views, there is shown in FIG. 1 a heat shield 100 comprising at least one wall 110 having a top edge 111 and a bottom edge 112. In some embodiments, top edge 111 and/or bottom edge 112 can be rounded. Wall 110 defines a generally tubular body which connects to a base 120 proximate bottom edge 112. Wall 110 can form a generally circular or ovular shell extending normal to base 120. Wall 110 can be optionally tapered at an angle β, as shown. Angle β can be at least about 3 degrees, at least about 4 degrees, or at least about 5 degrees. Angle β can be about 3 degrees to about 17 degrees, about 4 degrees to about 16 degrees, or about 5 degrees to about 15 degrees. Alternatively, wall 110 can comprise a plurality of walls which form a generally hollow shell. Such a hollow shell can comprise various cross-sectional shapes, dependent upon the number of walls, including hemispherical, triangular, square, etc.

Wall 110 and base 120 converge to define a bottom diameter 125. Bottom diameter 125 can be an average diameter in embodiments where bottom diameter 125 is not uniform. Base 120 can comprise an aperture 130. As illustrated, aperture 130 is centered relative to a central axis 135, however other aperture 130 positions can be suitable. Aperture 130 can be capable of receiving an object, such as a gas sensor. In particular, the aperture is capable of receiving an O2 sensor. Aperture 130 can comprise a shape (e.g., a circular shape) suitable for accepting an object, such as a gas sensor.

Wall 110 can adjoin a circumferential lip 140 proximate wall top edge 111, and extend radially outward relative to axis 135. In some embodiments, the lip can optionally also extend inward relative to axis 135. Lip 140 can extend radially outward at a perpendicular angle relative to an axis of the body, as shown. The lip can alternatively extend radially outward at an angle α from the perpendicular relative to the axis 135 of the body. Angle α can be less than about +/−10 degrees, less than about +/−5 degrees, less than about +/−4 degrees, less than about +/−3 degrees, less than about +/−2 degrees, or less than about +/−1 degree. Angle α can be less than about 10 degrees, less than about 5 degrees, less than about degrees, less than about degrees, less than about degrees, or less than about degree. Lip 140 can extend radially outward from the wall 110 and define an outer lip diameter 145. Outer lip diameter 145 can be an average diameter in embodiments where outer lip diameter 145 is not uniform. The ratio of the outer lip diameter 145 to body bottom diameter 125 can be at least about 5:3.5, at least about 5:3.4, at least about 5:3.3, at least about 5:3.2, at least about 5:3.1, or at least about 5:3.0.

Heat shield 100 can have a height 136 defined as the normal distance between base 120 and top edge 111. In some embodiments, heat shield can optionally have a height 136 to bottom diameter 125 ratio of less than about 1:2.5, less than about 1:2.25, less than about 1:2, or less than about 1:1.75.

Heat shield 100 can comprise a metal, such as steel, which is capable of maintaining the described physical shape and structural stability under various operating conditions. Operating conditions can be those proximate an ICEs and/or exhaust gas manifold or conduit, and include temperatures in excess of 500° C., 550° C., or 600° C. Steel can include stainless steel, or SUS-304L, for example. For heat shields 100 comprising metal constructions, lip 140 can include a countered or folded lip edge to prevent damage to nearby components by sharp edges.

In a particular embodiment, heat shield 100 comprises at least one wall extending normal to base 120, a lip 140 extending radially outward at a perpendicular angle relative to axis 135 of the body, and an outer lip diameter 145 to body bottom diameter 125 ratio of at least about 5:3.5. Optionally this heat shield 100 can comprise a height 136 to bottom diameter 125 ratio of less than about 1:2.5.

In a particular embodiment, heat shield 100 comprises at least one wall extending normal to base 120, a lip 140 extending radially outward at a perpendicular angle relative to axis 135 of the body, and an outer lip diameter 145 to body bottom diameter 125 ratio of at least about 5:3.25. Optionally this heat shield 100 can comprise a height 136 to bottom diameter 125 ratio of less than about 1:2.5.

In a particular embodiment, heat shield 100 comprises at least one wall extending normal to base 120, a lip 140 extending radially outward at a perpendicular angle relative to axis 135 of the body, and an outer lip diameter 145 to body bottom diameter 125 ratio of at least about 5:3. Optionally this heat shield 100 can comprise a height 136 to bottom diameter 125 ratio of less than about 1:2.5.

In a particular embodiment, heat shield 100 comprises at least one wall extending from base 120 at an angle β of at least 3 degrees, a lip 140 extending radially outward at a perpendicular angle relative to axis 135 of the body, and an outer lip diameter 145 to body bottom diameter 125 ratio of at least about 5:3.5. Optionally this heat shield 100 can comprise a height 136 to bottom diameter 125 ratio of less than about 1:2.5.

In a particular embodiment, heat shield 100 comprises at least one wall extending from base 120 at an angle β of at least 3 degrees, a lip 140 extending radially outward at a perpendicular angle relative to axis 135 of the body, and an outer lip diameter 145 to body bottom diameter 125 ratio of at least about 5:3.25. Optionally this heat shield 100 can comprise a height 136 to bottom diameter 125 ratio of less than about 1:2.5.

In a particular embodiment, heat shield 100 comprises at least one wall extending from base 120 at an angle β of at least 3 degrees, a lip 140 extending radially outward at a perpendicular angle relative to axis 135 of the body, and an outer lip diameter 145 to body bottom diameter 125 ratio of at least about 5:3. Optionally this heat shield 100 can comprise a height 136 to bottom diameter 125 ratio of less than about 1:2.5.

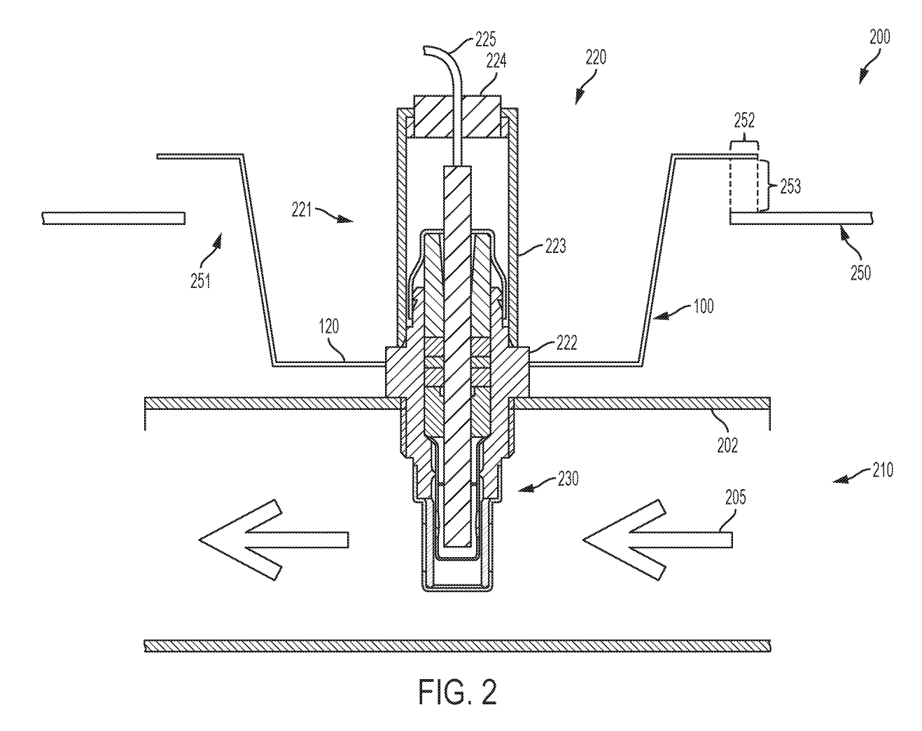

FIG. 2 illustrates an exhaust gas monitoring system 200 including an exhaust gas conduit 210, a gas sensor 220 disposed within the exhaust gas conduit 210, and heat shield 100 situated proximate gas sensor 220. Exhaust gas conduit 210 includes a wall 202 defining a passage through which exhaust gas 205 can collect or travel. Exhaust gas 205 can be supplied by an ICE (not pictured), for example. Exhaust gas can include one or more of carbon dioxide (CO₂), water (H₂O), oxygen (O₂), diatomic nitrogen (N₂), carbon monoxide (CO), unburned hydrocarbons, oxides of nitrogen (NOₓ), oxides of sulfur (SOₓ), and condensed phase materials (liquids and solids) that constitute particulate matter. Exhaust gas 205 can be supplied via exhaust gas conduit 210 to a turbocharger, for example. Gas sensor 220 can comprise an O₂ sensor, for example, and generally comprises a first end 230 disposed within exhaust gas conduit 210 and a second end 221 disposed outside exhaust gas conduit 210. First end 230 can be configured to receive a gas sample from exhaust gas conduit 210. For example, first end 230 can be configured to receive an exhaust gas 205 sample. Gas sensor 220 can comprise a body 222, for example a metal body, which can be oriented contiguous with an exhaust gas conduit 210 aperture through which gas sensor 220 is disposed. Body 222 can form a fluid-tight seal with wall 202, for example.

Gas sensor 220 can comprise an outer shell 223, for example for maintaining a fluid-tight environment about the various internal components. Gas sensor 220 can comprise one or more lead wires 225 which extend beyond the outer shell 223 through an aperture, said aperture occupied by a grommet 224 to maintain the fluid-tight characteristics of shell 223. Grommet 224 can comprise a rubber, polytetrafluoroethylene (PTFE), resin, polyimide, or other elastomeric material. Gas sensor 220 can be heat-sensitive. The performance of gas sensor 220 can be detrimentally impacted by excessive heat, particularly heat contacting second end 221. It should be noted that the description and figure of gas sensor 220 is not meant to limit the application of the present disclosure to a particular type of gas sensor. It should further be noted that heat shield 100 and gas sensor 210 are not necessarily drawn to scale relative to each other, and/or to the diameter of the exhaust gas conduit 210 or thickness of the exhaust gas conduit wall 202.

Gas sensor 220 is shown disposed within heat shield aperture 130. Heat shield 100 can be contiguous with one or more of body 222, outer shell 223, and wall 202. For example, an outer contour of body 222 can substantially conform to aperture 130. Heat shield 100 base 120 can comprise attachment features, such as one or more of threads, bolt holes, and tabs for securing heat shield to one or more of gas sensor 220 and wall 202. Heat shield 100 can advantageously, reduce, minimize, or prevent excess heat from contacting second end 221, and/or grommet 224. The characteristics of heat shield 100 can lend heat-shielding capabilities to gas sensor 220 even when gas sensor 220 extends vertically beyond the height 163 of heat shield 100. Accordingly, heat shield 100 need not entirely cover gas sensor 220, thereby reducing manufacturing costs, weight, and saving space within system 200.

System 200 can further comprise an engine and/or turbocharger shield 250. Gas sensor 220 and heat shield 100 can be disposed within an aperture 251 of shield 250. Heat shield 100 lip 140 can be oriented above shield 250 relative to exhaust gas conduit 210, as shown. In such embodiments, the length of lip 140 can be determined based upon an overlap distance 252 between lip 140 and shield 250, rather than as an outer lip diameter 145 to body bottom diameter 125 ratio. In some embodiments, overlap 252 is at least 8 mm, at least 9 mm, or at least 10 mm. In some embodiments, lip 140 is substantially parallel to shield 250. In other embodiments, lip 140 is not substantially parallel to shield 250. In such embodiments, overlap 252 comprises an average overlap. Optionally, heat shield 100 height 136 can be determined based on a vertical gap 253 between lip 140 and shield 250. In some embodiments, vertical gap 253 is at most 9 mm, at most 8 mm, or at most 7 mm. In some embodiments, lip 140 is substantially parallel to shield 250. In other embodiments, lip 140 is not substantially parallel to shield 250. In such embodiments, vertical gap 253 comprises an average vertical gap.

In system 200, heat shield 100 is capable of protecting gas sensor 220 from damaging heat in temperature conditions which exceed at least about 500° C., at least about 550° C., or at least about 600° C. Damaging heat can be defined as a temperature threshold above which gas sensor 220 cannot suitably operate, or as a temperature threshold above which one or more components (e.g., grommet 224) of gas sensor 220 are irreparably damaged.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A gas sensor heat shield comprising:
at least one wall having a top edge and a bottom edge, the wall forming a body;
a base connected proximate the wall bottom edge defining a bottom diameter and a normal height relative to the wall top edge, the base including an aperture capable of receiving a gas sensor; and
a circumferential lip proximate the wall top edge extending radially outward and defining an outer lip diameter;
wherein the at least one wall is tapered radially outward at an angle of about 3 degrees to about 17 degrees, and the ratio of the outer lip diameter to bottom diameter is at least about 5:3.5.

2. The heat shield of claim 1, wherein the lip extends radially outward at a perpendicular angle relative to an axis of the body.

3. The heat shield of claim 1, wherein the lip extends radially outward at an angle less than about +/−10 degrees from the perpendicular relative to an axis of the body.

4. The heat shield of claim 1, wherein one or more of the wall, the base, and lip comprise steel.

5. The heat shield of claim 1, wherein the height to the bottom diameter ratio is less than about 1:2.5.

6. An exhaust gas monitoring system, the system comprising:
an exhaust gas conduit including a wall defining a passage through which exhaust gas can collect or travel;
a gas sensor having a first end disposed within the exhaust gas conduit and a second end disposed outside the exhaust gas conduit; and
gas sensor heat shield including:
at least one wall having a top edge and a bottom edge, the wall forming a body;
a base connected proximate the wall bottom edge defining a bottom diameter and a normal height relative to the wall top edge, the base including an aperture through which the gas sensor is positioned; and
a circumferential lip proximate the wall top edge extending radially outward and defining an outer lip diameter;
wherein the at least one wall is tapered radially outward at an angle of about 3 degrees to about 17 degrees, and the ratio of the outer lip diameter to bottom diameter is at least about 5:3.5.

7. The system of claim 6, wherein the heat shield lip extends radially outward at a perpendicular angle relative to an axis of the body.

8. The system of claim 6, wherein the heat shield lip extends radially outward at an angle less than about +/−10 degrees from the perpendicular relative to an axis of the body.

9. The system of claim 6, wherein the heat shield wall, the base, and lip comprise steel.

10. The system of claim 6, wherein the heat shield height to the bottom diameter ratio is less than about 1:2.5.

11. The system of claim 6, wherein the heat shield is capable of protecting the gas sensor from damaging heat in temperature conditions which exceed at least about 500° C.

12. The system of claim 6, wherein the gas sensor extends vertically beyond the height of the heat shield.

13. An exhaust gas monitoring system, the system comprising:
an exhaust gas conduit including a wall defining a passage through which exhaust gas can collect or travel;
a gas sensor having a first end disposed within the exhaust gas conduit and a second end disposed outside the exhaust gas conduit;
an engine and/or turbocharger shield including an aperture; and
a gas sensor heat shield disposed within the engine and/or turbocharger shield aperture, the gas sensor heat shield including:
at least one wall having a top edge and a bottom edge, the wall forming a body;
a base connected proximate the wall bottom edge defining a bottom diameter and a normal height relative to the wall top edge, the base including an aperture through which the gas sensor is positioned; and
a circumferential lip proximate the wall top edge extending radially outward and defining an outer lip diameter;
wherein the at least one wall is tapered radially outward at an angle of about 3 degrees to about 17 degrees; and the lip is positioned above the engine and/or turbocharger shield relative to the exhaust gas conduit and overlaps the engine and/or turbocharger shield at least 8 mm.

14. The system of claim 13, wherein the heat shield lip extends radially outward at a perpendicular angle relative to an axis of the body.

15. The system of claim 13, wherein the heat shield wall, the base, and lip comprise steel.

16. The system of claim 13, wherein the heat shield height to the bottom diameter ratio is less than about 1:2.5.

17. The system of claim 13, wherein a vertical gap between the heat shield lip and engine and/or turbocharger shield is at most 9 mm.

18. The system of claim 13, wherein the heat shield is capable of protecting the gas sensor from damaging heat in temperature conditions which exceed at least about 500° C.

19. The system of claim 13, wherein the gas sensor extends vertically beyond the height of the heat shield.

20. The system of claim 13, wherein the ratio of the heat shield outer lip diameter to the bottom diameter is at least about 5:3.5.
